(19) United States
(12) Patent Application Publication
(10) Pub. No.: US 2005/0066204 A1
(43) Pub. Date: Mar. 24, 2005

(54) Auto-green power savings on multi-channel transceiver

(76) Inventors: Henry Wong, Sunnyvale, CA (US); Raymond Chow, Sunnyvale, CA (US)

Correspondence Address: LAW OFFICES OF CLEMENT CHENG, 17220 NEWHOPE STREET #127, FOUNTAIN VALLEY, CA, 92708, US

(21) Appl. No.: 10/653,672

(22) Filed: Sep. 2, 2003

(51) Int. Cl. G06F 1/26

(52) U.S. Cl. 713/320

(57) ABSTRACT

An auto power saving device for multi-channel transceiver comprises at least one tier and five levels, in which the five levels comprises an input level for each tier having at least one input and producing a time delayed binary signal, a NAND gate level having one NAND gate for each tier, each NAND gate receiving a signal from its respective input and from the output of an upper neighboring NAND gate if such NAND gate exists and from the output of a lower neighboring NAND gate if such NAND gate exists, an inverter level comprising one inverter per tier receiving and inverting said signal from its respective NAND gate, and a NOR gate level comprising one NOR gate that receives all inputs from all inverters on all tiers, and an Output Level producing an output signal.

U.S. Pat. No. 6,000,003 is a continuation-in-part of application U.S. Pat. No. 5,799,194, which is a continuation-in-part of application U.S. Pat. No. 5,649,210.

### BACKGROUND OF THE INVENTION

Modern portable electronic devices put high demands for power on portable power sources such as batteries. In the case of portable computer, there is a need to reduce power consumption when there are features linked to the portable computer not in directly use. To reduce the power consumption of such cases, circuits have been designed which detect when the interfaced devices are not required, or disconnected, then power down those interfaced devices.

### DISCUSSION OF RELATED ART

In 1994, Allen's “Communication Interface Circuit Having Network Connection Detection Capacity” (U.S. Pat. No. 5,649,210) first introduced the circuit design which detects signals from coupled interface devices in an established network connection, and determine the providing of power to said devices. The interface circuit can internally turn on without intervention or control by the computer system if the signals were valid. If the signals are detected invalid by the circuit, the power will be suspended so that overall power consumption by the computer system is reduced.

Allen again in U.S. Pat. No. 5,799,194 and U.S. Pat. No. 6,000,003 advanced his original idea as the circuit in addition to detecting signals from the coupled interfaced devices, also detects status of driver's input before starting a time delay to shut down the power supply. Allen attached several embodiments in U.S. Pat. No. 5,799,194 showing the possible application of said invention.

In both U.S. Pat. No. 5,649,210 and U.S. Pat. No. 6,000,003, in order to trigger a final signal to start a time delay, all signals from all interfaced devices will be detected together through an AND gate. Only when the signals are all valid, the final signal will be triggered.

Fujimoto (U.S. Pat. No. 6,104,937), in 2000, advance this power-saving scheme into wireless field. Applying the traditional power-saving idea in network base stations into mobile terminals.

Recently in 2002, Chan (U.S. Pat. No. 6,378,026) used an accumulated delay circuit that indicates whether the corresponding input terminal is connected to an active communication device, so that each delay circuit provides a delayed output signal to a subsequent delay circuit activating a predetermined period of delay time.

### OBJECT OF THE INVENTION

The present invention relates to a connection detection circuit with a Reset-Set Latch, in which it detects the connectivity between two systems or circuits, set or reset the power savings objective by shutting down or powering off the system that is not in use, and resets the operation of communications between two systems or circuits when the systems or the circuits are ready to transmit or receive again.

Avoiding the inefficiency of AND-ing multiple channels to generate the final power-savings control signal. Avoiding the inefficiency of accumulating channel-specified time delays.

### SUMMARY OF THE INVENTION

Methods and apparatus are presented which sense the characteristic of the communication lines to control, indicate, or provide signal to manipulate the amount of power being delivered to the communication lines and/or other substantial power consuming circuitry so as to reduce, conserve, and save power to such circuits when they become not in use. Embodiments for detecting or sensing the proper or improper connectivity, and set or reset to execute the power down or power up functions are disclosed.

### FIELD OF INVENTION

The present invention relates to digital communication interface, particularly, an invention relates to a communication interface circuit, which detects the connectivity and executes power savings activity in the communication and power management systems.

### DESCRIPTION OF THE DRAWINGS

FIG. 1 is a circuit diagram illustrating a preferred embodiment of a communication interface circuit having automatic detection and execution in accordance with the invention

FIG. 2 is a circuit diagram illustrating the second embodiment of a communication interface circuit having automatic detection and execution in accordance with the invention.

### DETAILED DESCRIPTION OF THE INVENTION

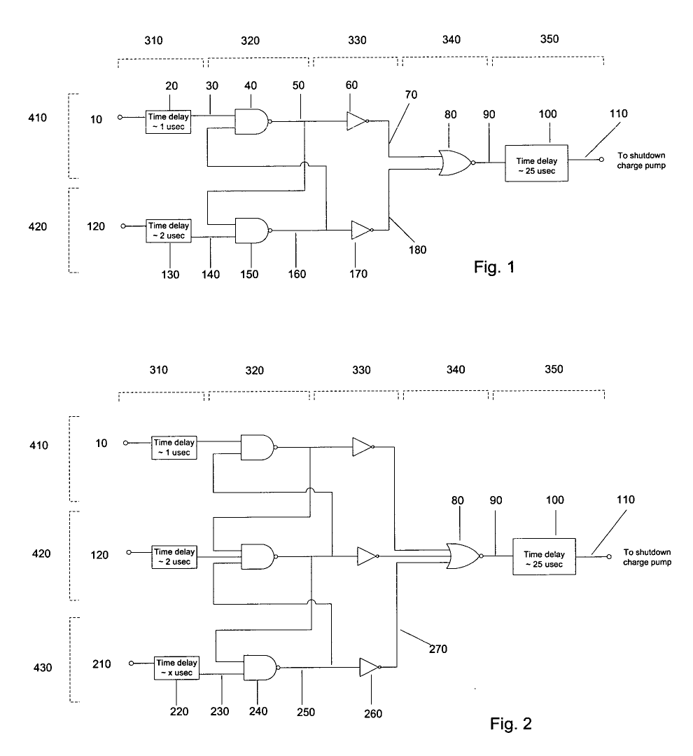

FIG. 1 illustrates an embodiment of the automatic connection detection circuit block of the invention. In the embodiment shown, the input terminals 10, 120 indicate the input status of communication connection device, such as RS-232 Receiver. It is possible to have only one input terminal, two or more than two input terminals in the invention.

The shown embodiment can be divided into five levels, which are Input Level 310, NAND gate Level 320, Inverter Level 330, NOR gate Level 340, and Output Level 350. Additionally the shown embodiment can be divided into tiers. One tier includes a receiver input, a NAND gate, and an Inverter, in which the output of the Inverter of all tiers become the inputs of the NOR gate 340.

In Input Level 310 first input, status of receiver input signal 10 passes through a time delay block 20 with an output signal 30 after approximately 1 μsec. The time delay block 20 outputs a logic HIGH signal 30 in response to the input signal 10 of logic HIGH approximately 1 μsec later. The time delay block 20 outputs a logic LOW signal 30 in response to the input signal 10 of logic LOW approximately 1 μsec later. For the second input, the status of receiver input signal 120 passes through a time delay block 130 with an output signal 140 after approximately 2 μsec. The time delay block 130 outputs a logic HIGH signal 140 in response to the input signal 120 of logic HIGH approximately 2 μsec later. The time delay block 130 outputs a logic LOW signal 140 in response to the input signal 120 of logic LOW approximately 1 μsec later.

The time delay blocks 20 and 130 are not limited to be in approximately 1 μsec or in approximately 2 μsec, respectively, but can be in any appropriate time delays such that a non-synchronous transition would not present to the subsequent circuit blocks 40 and 150.

In the NAND gate Level 320, the output signal 30 of time delay block 20 becomes one of the inputs of the NAND gate 40. The output signal 140 of time delay block 130 becomes one of the inputs of the NAND gate 150. The output 160 of the NAND gate 150 serves as the second input of the NAND gate 40, while the output 50 of the NAND gate 40 serves as the second input of the NAND gate 150. This cross-coupled connection, together with the NAND gate 40 and NAND gate 150, provides a Reset-Set Latch function.

The upper NAND gate 40 does not have any NAND gate connected upper, while the lower NAND gate 150 does not have any NAND gate connected lower.

When the input signal 30 is at logic HIGH, if the second input of the NAND gate 40 is at logic HIGH, the output signal 50 of the NAND gate 40 would be at logic LOW. When the input signal 30 is at logic HIGH, if the second input 160 of the NAND gate 40 is at logic LOW, the output signal 50 of the NAND gate 40 would be at logic HIGH. When the input signal 30 is at logic LOW, if the second input 160 of the NAND gate 40 is at logic HIGH, the output signal 50 of the NAND gate 40 would be at logic HIGH. When the input signal 30 is at logic LOW, if the second input 160 of the NAND gate 40 is at logic LOW, the output signal 50 of the NAND gate 40 would be at logic HIGH.

Similarly, when the input signal 140 is at logic HIGH, if the second input 50 of the NAND gate 150 is at logic HIGH, the output signal 160 of the NAND gate 150 would be at logic LOW. When the input signal 140 is at logic HIGH, if the second input 50 of the NAND gate 150 is at logic LOW, the output signal 160 of the NAND gate 150 would be at logic HIGH. When the input signal 140 is at logic LOW, if the second input 50 of the NAND gate 150 is at logic HIGH, the output signal 160 of the NAND gate 150 would be at logic HIGH. When the input signal 140 is at logic LOW, if the second input 50 of the NAND gate 150 is at logic LOW, the output signal 160 of the NAND gate 40 would be at logic HIGH.

In an alternative embodiment the Reset-Set Latch can have more than two NAND gates, and input terminals of the NAND gate can have more than two terminals.

In the Converter Level, the output signal 50 of the NAND gate 40 also becomes the input signal of the inverter 60 with output signal 70. When the input signal 50 of the inverter 60 is at logic HIGH, the output signal 70 will be at logic LOW; when the input signal 50 of the inverter 60 is at logic LOW, the output signal 70 will be at logic HIGH. Similarly, the output signal 160 of the NAND gate 150 also becomes the input signal of the inverter 170 with output signal 180. When the input signal 160 of the inverter 170 is at logic HIGH, the output signal 180 will be at logic LOW; when the input signal 160 of the inverter 170 is at logic LOW, the output signal 180 will be at logic HIGH.

The upper Converter 60 does not have any Converter connected upper, while the lower Converter 170 does not have any Converter connected lower.

In the NOR gate Level 340, both the output signals 70 and 180 become the input signals of the NOR gate 80, with an output signal 90. When either or both of the input signals 70 and 180 are at logic HIGH, the output signal 90 would be at logic LOW. When both of the input signals 70 and 180 are at logic LOW, the output signal 90 would be at logic HIGH.

In the Output Level 350, the output signal 90 of the NOR gate 80 becomes the input signal to the time delay block 100, which would generate an output signal 110 in response to the input signal after approximately 25 μsec later. If the input signal 90 is at logic HIGH, after the time delay block 100, the output signal 110 would be at logic HIGH approximately after 25 μsec. If the input signal 90 is at logic LOW, after the time delay block 100, the output signal 110 would be at logic LOW approximately after 25 μsec.

In an alternative embodiment the time delay block 100 can have any appropriate time delay corresponds to the overall circuit requirement. This time delay block 100 not only introduces time delay but also produces glitch-free output signal 110, which serves as the determining signal to shutdown or power-off any power consuming circuits or blocks when deemed necessary.

When the status of the input signal 10 indicates no activity at the communication links, either by disconnection of the communication cable or by powering down the transmitter side of the communication cable, and when the status of the input signal 120 indicates no activity at the communication links, either by disconnection of the communication cable or by powering down the transmitter side of the communication cable, after going through time delay blocks 20 and 130, the cross-coupled Reset-set latch would either reset or set the output signals 50 and 160, which in turns, would go through glitch-free time delay block 100 and produces a HIGH output signals 110 indicating no activity is detected at the communication links, and shutting-down the power.

Alternatively, referring to FIG. 2 as the second embodiment, the input terminals are not limited to two. Third, forth, or more input terminals can be added into present invention. It is shown on FIG. 2 as “receiver X input status”. X indicates the number of the inputs.

In Input Level 310, the time delay blocks 220 is not limited in approximately 1 μsec or in approximately 2 μsec, respectively, but can be in any appropriate time delays such that a non-synchronous transition would not present to the subsequent circuit blocks. Is is shown on FIG. 2 as “time delay ˜x usec”.

In the NAND gate Level 320, the output signal 230 of time delay block 220 becomes one of the inputs of the NAND gate 240. The output 160 of the NAND gate 150 serves as the second input of the NAND gate 240, while the output 250 of the NAND gate 40 serves as the third input of the NAND gate 150. This Reset-Set Latch, together with the NAND gate 40, NAND gate 150, and NAND gate 240 provides a trio Reset-Set Latch function.

When the input signal 230 is at logic HIGH, if the second input of the NAND gate 240 is at logic HIGH, the output signal 250 of the NAND gate 240 would be at logic LOW. When the input signal 230 is at logic HIGH, if the second input 160 of the NAND gate 240 is at logic LOW, the output signal 250 of the NAND gate 240 would be at logic HIGH. When the input signal 230 is at logic LOW, if the second input 160 of the NAND gate 240 is at logic HIGH, the output signal 250 of the NAND gate 240 would be at logic HIGH. When the input signal 230 is at logic LOW, if the second input 160 of the NAND gate 240 is at logic LOW, the output signal 250 of the NAND gate 240 would be at logic HIGH.

In the NOR gate Level 340, all the output signals 70, 180, and 270 become the input signals of the NOR gate 80, with an output signal 90. Only if all of the input signals 70, 180, and 270 are at logic LOW, the output signal 90 would be at logic HIGH. When either of the input signals 70, 180, or 270 is at logic HIGH, the output signal 90 would be at logic LOW.

Similarly, when the status of the input signal 210 indicates no activity at the communication links, either by disconnection of the communication cable or by powering down the transmitter side of the communication cable, after going through time delay blocks 220, the cross-coupled Reset-set latch would either reset or set the output signals 250, which in turns, would go through glitch-free time delay block 100 and produces a HIGH output signals 110 indicating no activity is detected at the communication links, and shutting-down the power.

The foregoing describes the preferred embodiments of the invention and modifications may be made without departing from the spirit and scope of the invention as set forth in the following claims.

| | |
|---|---|
| (10) Receiver Input Signal | (210) Receiver Input Signal |
| (20) Time Delay Block | (220) Time Delay Block |
| (30) Output signal | (230) Output Signal |
| (40) NAND gate | (240) NAND gate |
| (50) Output Signal | (250) Output Signal |
| (60) Inverter | (260) Inverter |
| (70) Output Signal | (270) Output Signal |
| (80) NOR Gate | (310) input level |
| (90) Output Signal | (320) NAND gate level |
| (100) Time Delay Block | (330) Inverter level |
| (110) Output Signal | (340) NOR gate level |
| (120) Receiver Input Signal | (350) output level |
| (130) Time Delay Block | (410) Tier One |
| (140) Output Signal | (420) Tier Two |
| (150) NAND Gate | (430) Tier X |
| (160) Output Signal | |
| (170) Inverter | |
| (180) Output Signal | |

1. An auto power saving device for multi-channel transceiver comprising: at least one tier and five levels, the five levels comprising: an input level for each tier having at least one input and producing a time delayed binary signal, a NAND gate level having one NAND gate for each tier, each NAND gate receiving a signal from its respective input and from the output of an upper neighboring NAND gate if such NAND gate exists and from the output of a lower neighboring NAND gate if such NAND gate exists, an inverter level comprising one inverter per tier receiving and inverting said signal from its respective NAND gate, and a NOR gate level comprising one NOR gate that receives all inputs from all inverters on all tiers, and an Output Level producing an output signal.

2. The device of claim 1, wherein all NAND gates have three inputs, wherein the output signal of the lowest NAND gate is introduced into the input of the highest signal.

3. The device of claim 1, wherein an extra input is introduced into the input of the first tier NAND gate so that the first tier input shares its NAND gate with the extra input.

4. The device of claim 1, wherein a plurality of extra inputs is introduced into open NAND gate inputs, wherein the NAND gates have more than 3 inputs.

5. The device of claim 1, wherein a high signal input in the input level indicates an activity input status, and a high signal output indicates a power off command.

6. The device of claim 1, wherein a low signal input in the input level indicates a no activity input status, and a low signal output indicates a non-power off command.

7. An auto power signal device for multi-channel transceiver power state processing comprising: an input level receiving a plurality of time delayed binary signals, a NAND gate level having a plurality of NAND gates receiving a signal from the input level, each NAND gate output introduced into the input of another NAND gate, an inverter level having a plurality of inverters receiving and inverting said signal from the NAND gate level, a NOR gate level having a NOR gate receiving all inputs from all inverters, and an Output Level outputting an output signal.

8. The device of claim 7, wherein all NAND gates have three inputs, wherein the output signal of the lowest NAND gate is introduced into the input of the highest signal.

9. The device of claim 7, wherein an extra input is introduced into the input of the first tier NAND gate so that the first tier input shares its NAND gate with the extra input.

10. The device of claim 7, wherein a plurality of extra inputs is introduced into open NAND gate inputs, wherein the NAND gates have more than 3 inputs.

11. The device of claim 7, wherein a high signal input in the input level indicates an activity input status, and a high signal output indicates a power off command.

12. The device of claim 7, wherein a low signal input in the input level indicates a no activity status, and a low signal output indicates a non-power off command.

13. An auto power saving method for multi-channel transceiver comprising the steps of: providing at least one tier; providing five levels comprising: providing an input level for each tier having at least one input and producing a time delayed binary signal, providing a NAND gate level having one NAND gate for each tier, each NAND gate receiving a signal from its respective input and from the output of an upper neighboring NAND gate if such NAND gate exists and from the output of a lower neighboring NAND gate if such NAND gate exists, providing an inverter level comprising one inverter per tier receiving and inverting said signal from its respective NAND gate, and providing a NOR gate level comprising one NOR gate that receives all inputs from all inverters on all tiers, and providing an output level and producing an output signal.

14. The method of claim 13, further comprising the step of using all three input NAND gates and introducing the output signal of the lowest NAND gate into the input of the highest signal.

15. The method of claim 13, further comprising the step of introducing an extra input into the input of the first tier NAND gate so that the first tier input shares its NAND gate with the extra input.

16. The method of claim 13, further comprising the step of introducing extra inputs into open NAND gate inputs, wherein the NAND gates have more than 3 inputs.

17. The method of claim 13, further comprising the step of indicating an activity status with a high signal input in the input level, and indicating a power off command with high signal output.

18. The method of claim 13, further comprising the step of indicating a no activity status with a low signal input in the input level, and indicating a non power off command with low signal output.
